(19) United States
(12) Patent Application Publication
(10) Pub. No.: US 2007/0236916 A1
(43) Pub. Date: Oct. 11, 2007

(54) Ligheing emitting devices used in knickers and brassiere

(76) Inventor: Shu-Ching Hsu, Taipei (TW)

Correspondence Address: SHU-CHING HSU, 235 Chung - Ho Box 8-24, Taipei, TW, TW

(21) Appl. No.: 11/401,439

(22) Filed: Apr. 11, 2006

(51) Int. Cl. F21V 21/08

(52) U.S. Cl. 362/103

(57) ABSTRACT

A pair of light emitting knickers comprises a pair of knickers having an edge strip; a light emitting unit being installed on the edge strip of the knickers through a combining unit; the light emitting unit including a flexible transmission line; the transmission line being bendable to be as characters or patterns on the edge strip; the transmission line being installed with a plurality of light emitting elements; a combining unit for combining the light emitting unit to the edge strip; wherein by the light emitting unit, the knickers can light up by actuating the light emitting elements of the light emitting unit. The light emitting unit has a control circuit board with a predetermined control way; and the control circuit board is installed with batteries and control switches. Moreover the light emitting unit can be used to a brassiere.

### FIELD OF THE INVENTION

The present invention relates to light emitting wears, and in particular to a pair of light emitting knickers and a light emitting brassiere, which are installed with light emitting unit. The light emitting unit has a transmission line with a plurality of light emitting elements so that the knickers and brassiere can present beautiful light effects.

### BACKGROUND OF THE INVENTION

In the current dress fashion, knickers and brassieres are well designed to present many novel effects so as to keep the attention of people.

Conventionally, the changes of the knickers and brassieres are concentrated on colors, shapes or decorations attached thereon. No light variation is provided. The light effect is fixed. Thus, their appearances must be presented through external light sources. However in the dark, the beautiful outlooks of these designs cannot be seen, but it is known that the knickers and brassieres are usually displayed at dark.

Thus, there is an eager demand for a novel design which can improve the defects in the prior art.

### SUMMARY OF THE INVENTION

Accordingly, the primary object of the present invention is to provide a pair of light emitting knickers and a light emitting brassiere, which are installed with light emitting unit. The light emitting unit has a transmission line with a plurality of light emitting elements so that the knickers and brassiere can present beautiful light effects.

To achieve above objects, the present invention provides a pair of light emitting knickers which comprises a pair of knickers having an edge strip; a light emitting unit being installed on the edge strip of the knickers through a combining unit; the light emitting unit including a flexible transmission line; the transmission line being bendable to be as characters or patterns on the edge strip; the transmission line being installed with a plurality of light emitting elements; a combining unit for combining the light emitting unit to the edge strip; wherein by the light emitting unit, the knickers can light up by actuating the light emitting elements of the light emitting unit. The light emitting unit has a control circuit board with a predetermined control way; and the control circuit board is installed with batteries and control switches. Moreover the light emitting unit can be used to a brassiere.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention, where the present invention is applied to knickers.

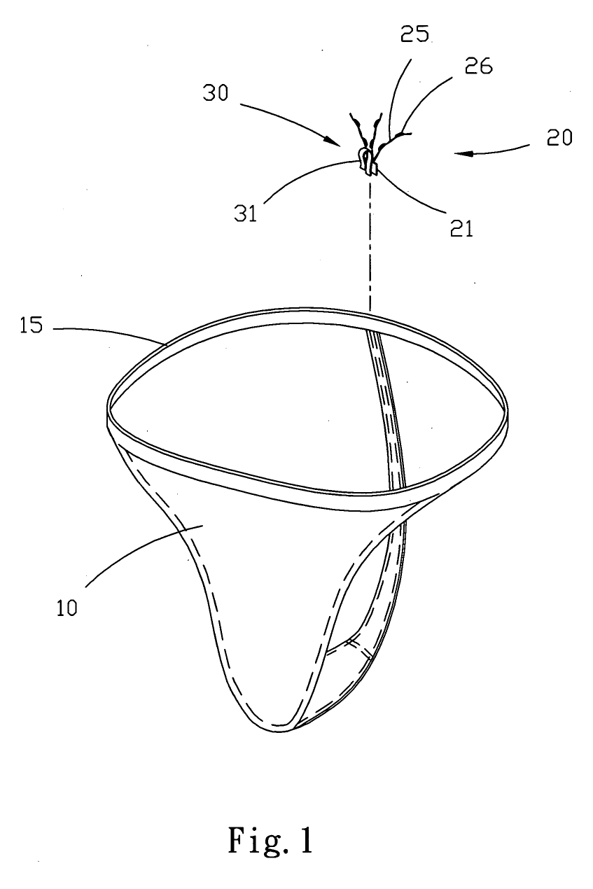

FIG. 2 is a schematic perspective view showing that the present invention is applied to knickers.

FIG. 3 is a schematic view showing that the present invention is applied to knickers.

FIG. 4 is another schematic view showing that the present invention is applied to knickers.

FIG. 5 is a further schematic view showing that the present invention is applied to kickers.

FIG. 6 is a schematic view showing another application of the present invention.

FIG. 7 is a schematic view showing a further application of the present invention.

FIG. 8 is a schematic perspective view showing that the present invention is used to a brassiere.

FIG. 9 is a schematic view showing one application that the present invention is used to a brassiere.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

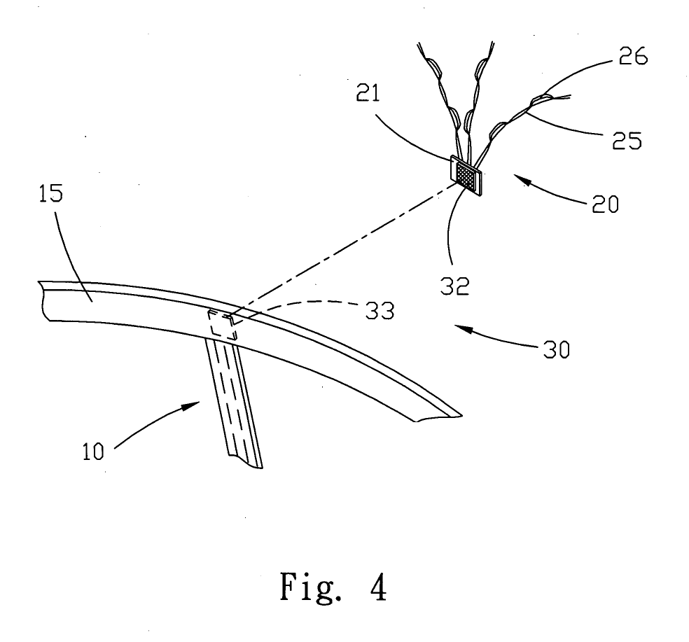

Referring to FIG. 4, the present invention relates to a light emitting structure which cause that a brassiere or knickers has a function of lighting up.

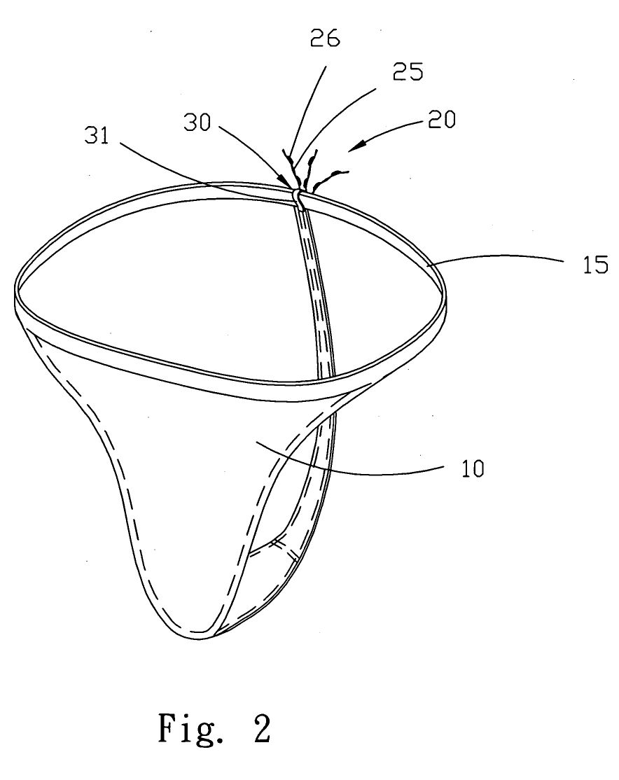

Referring to FIGS. 2, 3 and 4, a pair of knickers is used as an example. The present invention has the following elements.

A pair of knickers 10 has an edge strip 15. A light emitting unit 20 is installed on the edge strip 15 of the knickers 10 through a combining unit 30. The light emitting unit 20 has a control circuit board 21 with a predetermined control way. The control circuit board 21 is installed with batteries and control switches (not shown). The control circuit board 21 is connected to a flexible transmission line 25. The transmission line 25 is bendable to be as characters or patterns on the edge strip 15. The transmission line 25 is installed with a plurality of light emitting elements 26 which may have the same color or different colors.

The combining unit 30 is formed by a flexible clamping sheet 31. The clamping sheet 31 has a U shape so as to be hung on and clamp the edge strip 15. One side of the clamping sheet 31 is fixed to a backside of the control circuit board 21 of the light emitting unit 20 so that the light emitting unit 20 can be installed to the edge strip 15 of the knickers 10 by sticking, winding, buckling, etc. Furthermore, the light emitting unit 20 can be installed or detached easily and conveniently.

Thus the knickers 10 have the effect of lighting up through the light emitting elements 26 of the light emitting unit 20. Thereby the knickers 10 can present a beautiful effect.

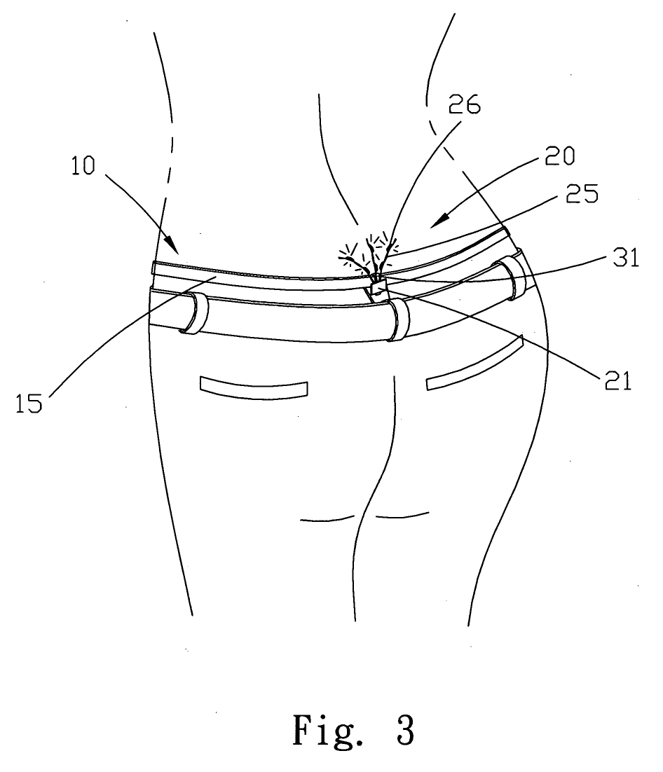

The use of the present invention will be referred to FIGS. 2 and 3. In use, the clamping sheet 31 serves to clamp the control circuit board 21 to the edge strip 15 of the knickers 10 and the transmission line 25 of the light emitting unit 20 exposes out. If it is desired to light up the light emitting unit 20, it is only necessary to press the switches on the control circuit board 21 to light up the light emitting elements 26 of the light emitting unit 20. Thereby the knickers 10 are as a decoration.

Referring to FIG. 4, another assembly way of the present invention is illustrated. The combining unit 30 is formed by two fastener tapes 32, 33. One fastener tape 32 is installed on the backside of the control circuit board 21 of the light emitting unit 20 and another fastener tape 33 is installed on the edge strip 15 of the knickers 10. Thus the present invention can be installed to the knickers 10 by the combination of the two fastener tapes 32, 33. Furthermore, the light emitting unit 20 can be detached easily.

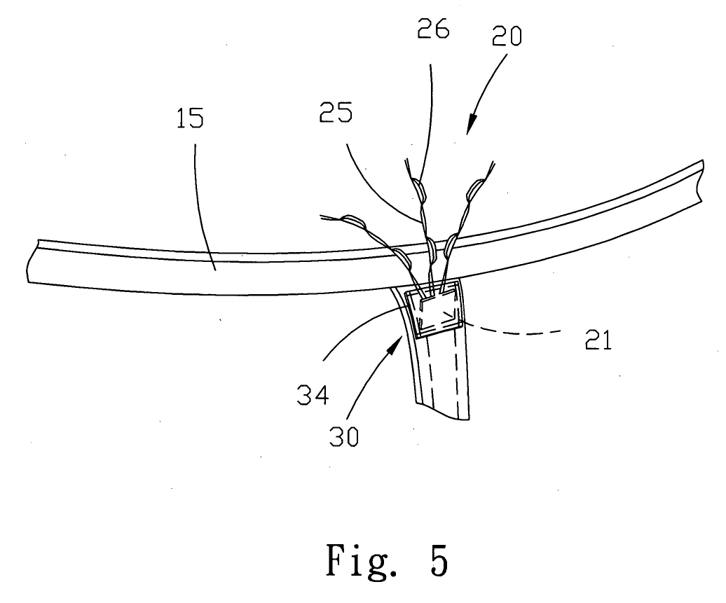

Referring to FIG. 5, another assembly way of the present invention is illustrated. In the control circuit board 21, a seaming sheet 34 is installed to the control circuit board 21 of the light emitting unit 20. The seaming sheet 34 can be seamed to the edge strip 15 of the knickers 10 so that the knickers 10 have the effect of light up. Thereby the light emitting unit 20 will not separate from the knickers 10.

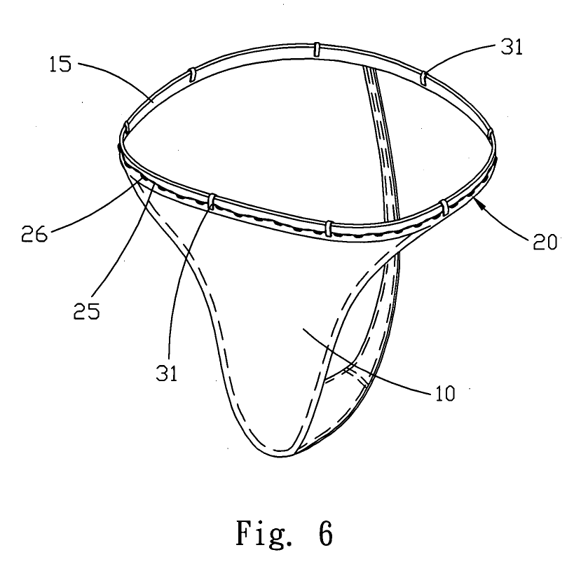

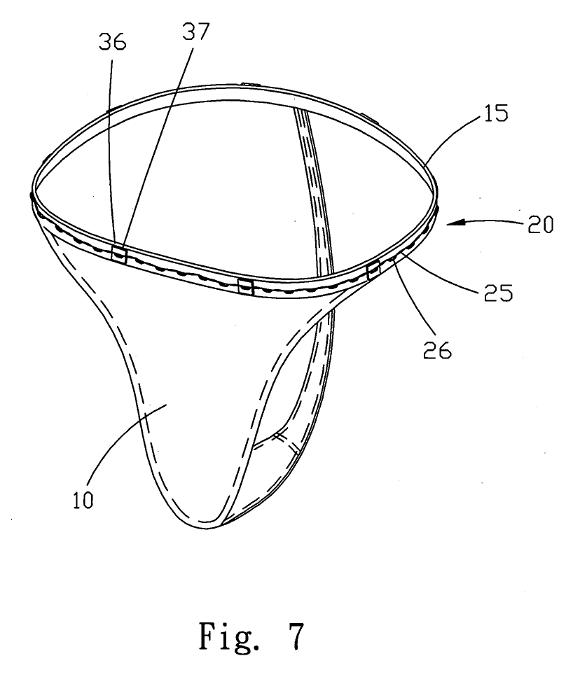

Referring to FIGS. 6, and 7, the transmission line 25 can be extended to a long length so that it can wind around all the edge strip 15 of the knickers 10. A flexible clamping sheet 35 is installed to the combining unit 30 at a position corresponding to the transmission line 25 (referring to FIG. 6). Thus the present invention can be installed to the knickers 10 by the combination of the two fastener tapes 32, 33. Furthermore, the light emitting unit 20 can be detached easily.

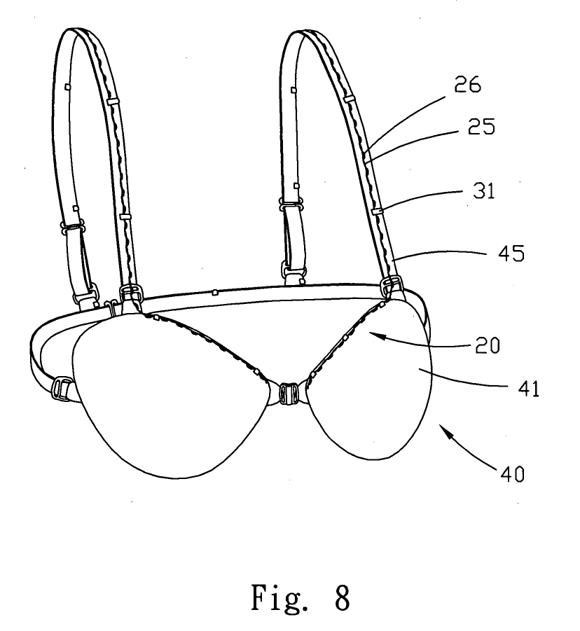

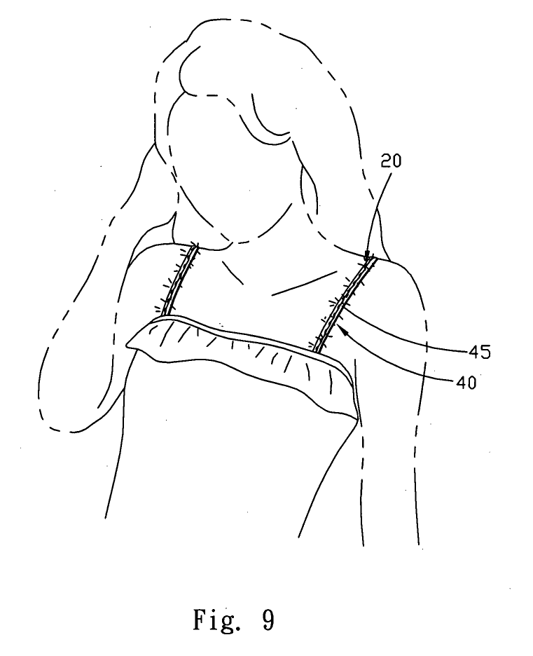

With reference to FIGS. 8 and 9, the present invention is applied to a brassiere 40 with masks 41 and shoulder strips 45. The light emitting unit 20 has a light emitting unit 20. The light emitting unit 20 has a transmission line 25. The transmission line 25 has a plurality of light emitting elements 26. A clamping sheet 31 serves to clamp the control circuit board 21 and transmission line 25 to one shoulder strip 45 and the mask. Thus the brassiere 40 has the effect of lighting up and as a decoration.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A pair of light emitting knickers comprising:
a pair of knickers having an edge strip;
a light emitting unit being installed on the edge strip of the knickers through a combining unit; the light emitting unit including a flexible transmission line; the transmission line being bendable to be as characters or patterns on the edge strip; the transmission line being installed with a plurality of light emitting elements;
a combining unit for combining the light emitting unit to the edge strip of the knickers;
wherein by the light emitting unit, the knickers can light up by actuating the light emitting elements of the light emitting unit; and
wherein the light emitting unit has a control circuit board with a predetermined control way; and the control circuit board is installed with batteries and control switches.

2. The pair of light emitting knickers as claimed in claim 1, wherein the plurality of light emitting elements have the same color or different colors.

3. The pair of light emitting knickers as claimed in claim 1, wherein the combining unit is a clamping sheet which has a U shape so as to be hung on and clamp the edge strip.

4. The pair of light emitting knickers as claimed in claim 3, wherein the clamping sheet is installed to the transmission line of the light emitting unit so as to be attached to the edge strip of the knickers.

5. The pair of light emitting knickers as claimed in claim 1, wherein the combining unit is formed by two fastener tapes; one fastener tape is installed on the backside of the control circuit board of the light emitting unit and another fastener tape is installed on the edge strip of the knickers; thus, the light emitting unit can be installed to the knickers by the combination of the two fastener tapes.

6. The pair of light emitting knickers as claimed in claim 1, wherein the combining unit is formed by two fastener tapes; one fastener tape is installed on the transmission line and another fastener tape is installed on the edge strip of the knickers; thus, the light emitting unit can be installed to the knickers by the combination of the two fastener tapes.

7. The pair of light emitting knickers as claimed in claim 1, wherein the combining unit is a seaming sheet which is installed to the control circuit board of the light emitting unit; the seaming sheet is seamed to the edge strip of the knickers so that the knickers has the effect of light up.

8. The pair of light emitting knickers as claimed in claim 1, wherein the light emitting unit is installed to the edge strip of the knickers by one of sticking, winding, and buckling.

9. A light emitting brassiere comprising:
a brassiere body having two masks and two shoulder strips;
at least one light emitting unit being installed on the brassiere body through a combining unit; the light emitting unit including a flexible transmission line; the transmission line being bendable to be as characters or patterns; the transmission line being installed with a plurality of light emitting elements;
at least one combining unit for combining the at least one light emitting unit to the mask and shoulder strip of the brassiere body;
wherein by the light emitting unit, the brassiere can light up by actuating the light emitting elements of the light emitting unit; and
wherein the light emitting unit has a control circuit board with a predetermined control way; and the control circuit board is installed with batteries and control switches.

10. The light emitting brassiere as claimed in claim 9, wherein the plurality of light emitting elements have the same color or different colors.

11. The light emitting brassiere as claimed in claim 9, wherein the combining unit is a clamping sheet which has a U shape so as to be hung on and clamp the brassiere body.

12. The light emitting brassiere as claimed in claim 11, wherein the clamping sheet is installed to the transmission line of the light emitting unit so as to be attached to the brassiere body.

13. The light emitting brassiere as claimed in claim 9, wherein the combining unit is formed by two fastener tapes; one fastener tape is installed on the backside of the control circuit board of the light emitting unit and another fastener tape is installed on the brassiere body; thus, the light emitting unit can be installed to the brassiere body by the combination of the two fastener tapes.

14. The light emitting brassiere as claimed in claim 9, wherein the combining unit is formed by two fastener tapes; one fastener tape is installed on the transmission line and another fastener tape is installed on the brassiere body; thus, the light emitting unit can be installed to the brassiere body by the combination of the two fastener tapes.

15. The light emitting brassiere as claimed in claim 9, wherein the combining unit is a seaming sheet which is installed to the control circuit board of the light emitting unit; the seaming sheet is seamed to the brassiere body so that the brassiere body has the effect of light up.

16. The light emitting brassiere as claimed in claim 9, wherein the light emitting unit is installed to the brassiere body by one of sticking, winding, and buckling.
